(19) United States
(12) Patent Application Publication
(10) Pub. No.: US 2012/0015275 A1
(43) Pub. Date: Jan. 19, 2012

(54) SOLID OXIDE FUEL CELL AND FUEL CELL STACK

(75) Inventor: Hyun-Min SON, Yongin-si (KR)

(73) Assignee: SAMSUNG SDI CO., LTD., Yongin-si (KR)

(21) Appl. No.: 13/165,458

(22) Filed: Jun. 21, 2011

(30) Foreign Application Priority Data
Jul. 16, 2010 (KR) 10-2010-0069036

(51) Int. Cl. H01M 8/24; H01M 8/04; H01M 8/10

(52) U.S. Cl. 429/459; 429/495

(57) ABSTRACT

A solid oxide fuel cell and a fuel cell stack are disclosed. The fuel cell stack may include a current collector electrically connected to inner and outer circumferential surfaces of a unit cell and a cap structure. The connection process between the current collector and the unit cell may be easily performed. As an external current collecting portion may be formed to surround the outer circumferential surface of the unit cell. Unit cells may be coupled to manifolds and electrically connected to one another.

### CROSS-REFERENCE TO RELATED APPLICATIONS

This application claims priority to and the benefit of Korean Patent Application No. 10-2010-0069036, filed on Jul. 16, 2010, in the Korean Intellectual Property Office, the entire content of which is incorporated herein by reference.

### BACKGROUND

1. Field of the Disclosure

The present disclosure relates to a solid oxide fuel cell and a fuel cell stack, and more particularly, to a solid oxide fuel cell and a fuel cell stack having an improved current collection structure.

2. Description of the Related Technology

In a fuel cell, an electrochemical reaction is performed. More specifically, oxygen and fuel gas are provided to a cathode and an anode within the fuel cell, respectively. The electrochemical reaction between the oxygen and the fuel produces electricity, heat and water. The fuel cell thus produces electricity at high efficiency without pollution.

A solid oxide fuel cell has current collectors formed on the inner and outer circumferential surfaces of an anode. In this configuration, the outer circumferential surface of the current collector necessarily and uniformly contacts the entire inner circumferential surface of the anode to prevent the degradation of current collection efficiency. The current collector formed on the outside of the anode is formed to be wound on the outer circumferential surface of the anode. In this configuration, contact resistance increases because of the line contact of the current collector with the anode. When a fuel cell stack is formed by coupling unit cells formed as described above to a manifold, such that the unit cells are connected to one another, the unit cells are also necessarily coupled to the manifold. The coupling process is not easy, and the current collector that contacts the anode is cut in the coupling process.

### SUMMARY OF CERTAIN INVENTIVE ASPECTS

In one aspect, a solid oxide fuel cell is provided in which the structure of a current collector in a unit cell is improved, so that the current collector can be easily formed in the unit cell, and current collection efficiency can be enhanced.

In another aspect, a solid oxide fuel cell stack is provided in which the structure of a current collector is improved, so that unit cells can be simply and firmly coupled to a manifold.

In another aspect, a current collection structure is improved, thereby simplifying the unit cell accommodation structure and flow-path structure of manifolds.

In another aspect, a solid oxide fuel cell includes, for example, a unit cell having a concentric tube structure in which a first electrode, an electrolytic layer and a second electrode are sequentially stacked and first and second current collectors electrically connected to one and the other end of the unit cell, respectively.

In some embodiments, at least one of the first and the second current collectors is formed on at least one of end and inner circumferential surfaces or end and outer circumferential surfaces of the unit cell. In some embodiments, the current collector includes a cover portion positioned on the entrance of the unit cell and an internal current collecting portion extending from a surface of the cover portion opposite to the unit cell configured for insertion into the interior of the unit cell. In some embodiments, the cover portion and the internal current collecting portion are integrally formed in a single body. In some embodiments, the current collector includes a cover portion positioned on the entrance of the unit cell and an external current collecting portion extending from a surface of the cover portion opposite to the unit cell to contact an outer circumferential surface of the unit cell. In some embodiments, the cover portion and the external current collecting portion are integrally formed in a single body. In some embodiments, the internal current collecting portion is formed in a hollow tubular shape so that its outer circumferential surface contacts an inner circumferential surface of the first electrode of the unit cell. In some embodiments, the external current collecting portion is formed in a hollow tubular shape so that its inner circumferential surface contacts an outer circumferential surface of the unit cell.

In some embodiments, the solid oxide fuel cell further includes a fuel supply port is formed in the cover portion. In some embodiments, the solid oxide fuel cell further includes an external current collecting portion formed on the outer circumferential surface of the end of the unit cell. In some embodiments, the external current collecting portion is positioned to surround an outer circumferential surface of the unit cell. In some embodiments, the solid oxide fuel cell further includes an internal current collecting portion formed on an inner circumferential surface of the end of the unit cell. In some embodiments, the internal current collecting portion contacts an inner circumferential surface of the unit cell. In some embodiments, the external current collecting portion is integrally formed with the cover portion and the internal current collecting portion. In some embodiments, flat portions are formed on at least one of the inner and outer circumferential surfaces of the unit cell. In some embodiments, the internal or external current collecting portion is formed on the flat portions. In some embodiments, the flat portions are formed along the outer circumferential surface of the unit cell. In some embodiments, the unit cell is formed into a polygonal structure. In some embodiments, the flat portions are locally formed at an end side of the unit cell. In some embodiments, at least one of the internal current collecting portion and cover portion and the external current collecting portion and cover portion is integrally formed in a single body. In some embodiments, the current collector includes a conductive ceramic material. In some embodiments, the current collector includes a porous structure.

In another aspect, a solid oxide fuel cell stack includes, for example, an assembly of a plurality of unit cells. In some embodiments, each of the plurality of unit cells includes a first electrode, an electrolytic layer and a second electrode, sequentially stacked therein and a manifold electrically connected to the plurality of unit cells.

In some embodiments, each of the unit cells includes a first current collector including a first cover portion provided at one end of the unit cell, a first internal current collecting portion connected to the first cover portion to contact an inner circumferential surface of the unit cell, and a first external current collecting portion electrically connected to the first cover portion to contact an outer circumferential surface of the unit cell. In some embodiments, each of the unit cells includes a second current collector including a second cover portion provided at the other end of the unit cell, a second internal current collecting portion connected to the second cover portion to contact the inner circumferential surface of the unit cell, and a second external current collecting portion electrically connected to the second cover portion to contact with the outer circumferential surface of the unit cell, In some embodiments, each of the unit cells includes insertion holes formed in the manifolds. In some embodiments, the insertion holes are configured to receive the first and second current collectors of the unit cells, respectively. In some embodiments, each of the unit cells includes a connection terminal is formed between the insertion holes. In some embodiments, the connection terminal is configured to electrically connect the current collectors of the unit cells to each other.

In some embodiments, the first current collector is electrically connected to the second current collector. In some embodiments, the first internal current collecting portion of the first current collector is longer than the second internal current collecting portion of the second current collector. In some embodiments, the first external current collecting portion of the first current collector is shorter than the second external current collecting portion of the second current collector. In some embodiments, the first and second external current collecting portions of the unit cells contact each other at both ends of each of the connection terminals in the manifolds. In some embodiments, a fuel supply port is formed in each of the first and second cover portions. In some embodiments, the fuel supply port is in fluid communication with the interior of each of the unit cells.

In some embodiments, at least one of the first cover portion and first internal current collecting portion of the first current collector and the second cover portion and second internal current collecting portion of the second current collector are integrally formed in a single body. In some embodiments, at least one of the first cover portion and first external current collecting portion of the first current collector and the second cover portion and second external current collecting portion of the second current collector are integrally formed in a single body. In some embodiments, at least one of the first and second current collectors is integrally formed in a single body. In some embodiments, at least one of the first and second current collectors includes a conductive ceramic material. In some embodiments, at least one of the first and second current collectors includes a porous structure.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain the principles of the present disclosure.

FIG. 1 is an entire sectional view schematically showing the joint structure between a unit cell and each current collector according to an embodiment of the present disclosure.

FIG. 2 is a schematic sectional view showing the shape of the unit cell and the joint structure of first and second current collectors.

FIG. 3 is a schematic sectional view showing the shape of the unit cell and the joint structure of first and second current collectors.

FIG. 4 is an entire sectional view schematically showing coupling structures between a unit cell and each current collector.

FIG. 5 is an entire sectional view schematically showing coupling structures between a unit cell and each current collector.

FIG. 6 is a schematic sectional view showing the structure of a manifold.

FIG. 7 is an entire sectional view schematically showing a stack with the external current collection structure between unit cells and manifolds in the state that the unit cells are coupled to each of the manifolds.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Similarly, when it is described that an element is “coupled” to another element, the another element may be “directly coupled” to the other element or “electrically coupled” to the other element through a third element. Parts not related to the description are omitted for clarity. Hereinafter, like reference numerals refer to like elements. In the drawings, the thickness or size of layers are exaggerated for clarity and not necessarily drawn to scale. Certain embodiments will be described in more detail with reference to the accompanying drawings, so that a person having ordinary skill in the art can readily make and use aspects of the present disclosure.

Generally, a unit cell of an anode supported fuel cell is formed into a multiple-tube structure in which an electrolytic layer and a cathode are sequentially stacked on the outer circumferential surface of a cylindrical anode.

A hollow-tube-shaped internal current collecting portion for internal current collection is formed on the inner circumferential surface of the anode of the unit cell. In this configuration, the internal current collecting portion in a flat plate state is inserted into the interior of the anode to form a cylindrical shape. In this configuration, the outer circumferential surface of the internal current collecting portion necessarily and uniformly contacts the anode throughout the entire inner circumferential surface of the anode so that it is possible to prevent the degradation of current collection efficiency.

The internal collecting portion in the flat plate state is necessarily formed in the cylindrical shape as described above. Such a process is manually performed for each unit cell structure. Hence, it is difficult to form the internal current collecting portion, and it is also difficult to implement the internal current collecting portion into an exactly circular structure. In this configuration, an external current collecting portion formed in a wire shape is wound on the outer circumferential surface of the anode. In this configuration, the external current collecting portion does not come in surface contact with the anode but comes in line contact with the anode because of the structure of a wire. Accordingly, contact resistance is increased because of a narrow contact area, and therefore, the current collection efficiency is poor.

Although the contact area may be increased by increasing the winding of the external current collecting portion, a cost of the external current collecting portion is also increased. Therefore, there is a net loss based on the cost materials versus an increased rate of current collection efficiency.

A fuel cell stack is formed by connecting unit cells to a manifold so that each of the unit cells are connected through the wire-shaped external current collecting portion. In this configuration, the unit cells in the connection state are necessarily connected to the manifold at the same time. Thus, the connecting process is difficult. Further, the external current collecting portion may easily be damaged during the connecting process.

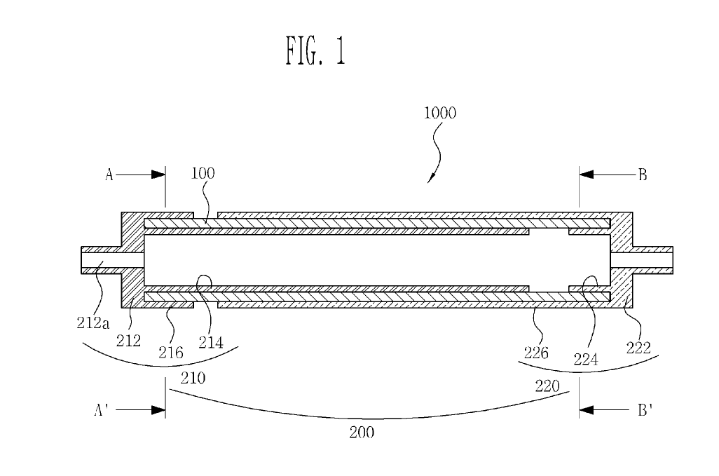

As shown in FIGS. 1 to 3, a solid oxide fuel cell 1000 according to an embodiment of the present disclosure includes a unit cell 100 having a stacked structure of a first electrode, an electrolytic layer and a second electrode; and current collecting collectors 200 respectively connected to both ends of the unit cell 100. As shown in FIG. 7, a fuel cell stack may have a configuration in which a plurality of fuel cells 1000 configured as described above are coupled to separate manifolds 400 so that they are electrically connected to one another.

For better understanding of the present disclosure, a first electrode, an electrolytic layer and a second electrode may be shown as one block, and the block is generally called as a unit cell 100. Also, reference numeral 1000 will refer to a solid oxide fuel cell so that the solid oxide fuel cell may be distinguished from the unit cell.

As described above, the unit cell 100 may be formed into a multiple-tube structure in which a first electrode, an electrolytic layer and a second electrode are sequentially stacked. Here, the first and second electrodes serve as an anode and a cathode, respectively, and the electrolytic layer serves as a path along which hydrogen and oxygen ions move.

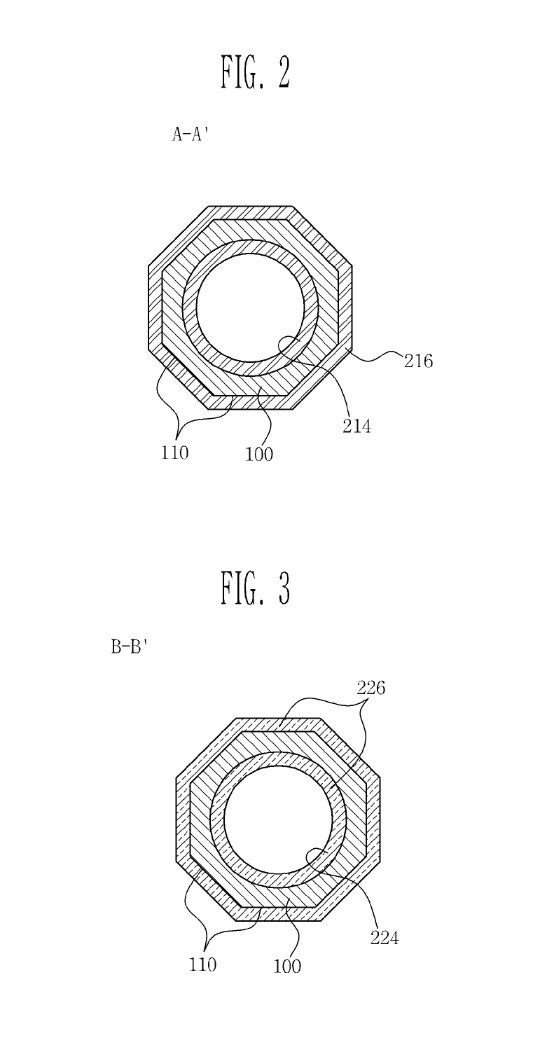

In this embodiment, as flat portions 110 are formed on the outer circumferential surface of the unit cell 100 as shown in FIGS. 2 and 3, the outer appearance of the unit cell 100 may be formed into a polyhedral structure unlike a general cylindrical unit cell. That is, in a configuration in which four flat portions 110 are formed on the outer circumferential surface of the unit cell 100, the outer appearance of the unit cell 100 has a quadrilateral tubular shape. In a configuration in which eight flat portions 110 are formed on the outer circumferential surface of the unit cell 100 as shown in these figures, the outer appearance of the unit cell 100 has an octagonal tubular shape.

The flat portions 110 are formed on the unit cell 100 so as to enhance coating efficiency in the process of forming external current collecting portions 216 and 226, which will be described later, on the outer circumferential surface of the unit cell 100 using a coating or deposition method. This is because the coating on a flat surface has a higher efficiency than that of a curved surface. As will be described later, the higher coating efficiency of the flat surface is also because as the external current collecting portions 216 and 226 are formed on the flat portions 110. Each of the external current collecting portions 216 and 226 stably contacts a connection terminal 420 in the connecting process between unit cells for external current collection.

Therefore, the forming position of the flat portions 110 may be formed on the entire outer circumferential surface of the second electrode at which the external current collection is performed in the unit cell 100. Further, the forming position of the flat portions 110 may be formed on a section exposed the an end portion of the anode in the electrolytic layer. However, since it may be difficult to manufacture the unit cell into a structure in which the flat portions are formed only on a partial section of the electrolytic layer, the entire electrolytic layer may be formed in a prismatic shape. In this configuration, the electrolytic layer and the second electrode (without the first electrode) are all formed into a polygonal tubular structure.

The number of the flat portions 110 is not limited, and may be varied in consideration of the diameter of the unit cell 100, the current collection capacity of the unit cell 100, and the like. Accordingly, the outer shape of the unit cell 100 is not limited to the octagonal shape shown in these figures but may be modified in various shapes.

A current collector 200 configured for internal and external current collection of the unit cell 100 is further provided to the unit cell 100. The current collector 200 includes a first current collector 210 for internal and external current collection at the side of the first electrode, for example, the anode, and a second current collector 220 for internal and external current collection at the side of the second electrode, for example, the cathode. The first current collector 210 may include a first internal current collecting portion 214, a first external current collecting portion 216 and a first cover portion 212. In this embodiment, the first internal current collecting portion 214 and the first cover portion 212 are integrally formed in a single body.

More specifically, as shown in FIG. 1, the cover portion 212 may be formed in the shape of a plate having an area greater than the sectional area of an end of the unit cell, particularly an end surface at the side of the anode. A fuel supply port 212a is formed at the center of the first cover portion 212. The fuel supply port 212a is dimensioned and configured to receive hydrogen gas for the unit cell 100. The material used to form the first cover portion 212 may be identical to that of the first internal current collecting portion 214 which will be described later. The first cover portion 212 may be formed to cover the entrance of the anode of the unit cell 100. The first cover portion 212 may be fixed to the unit cell 100 through a brazing method, or the like.

The first internal current collecting portion 214 may be formed on the inner circumferential surface of the unit cell to extend in a length direction of the unit cell 100 from the first cover portion 212. The first internal current collecting portion 214 may be configured to serve as a current collector at the side of the anode. The first internal current collecting portion 214 may be formed in a cylindrical shape having an external diameter identical to the internal diameter of the unit cell, for example, the internal diameter of the anode. The first internal current collecting portion 214 may be inserted into the interior of the anode so that that its outer circumferential surface contacts the inner circumferential surface of the anode. In this configuration, one end of the first internal current collecting portion 214 may be formed integrally connected to the inner surface of the first cover portion 212.

Unlike the stacked structure of felt-Ni mesh in an internal current collecting portion, the first internal current collecting portion 214 is not formed of a high-priced Ni mesh, but instead may be formed of a ceramic material having high specific resistivity and a similar chemical property to the unit cell 100. Accordingly, the structure of the first internal current collecting portion 214 may be simpler than a structure, which includes a felt-Ni mesh, and manufacturing cost can be saved by using different materials.

In some embodiments, the first cover portion 212 and the first internal current collecting portion 214 may have a porous structure. Further, as the first internal current collecting portion 214 may be formed of a simple circular ceramic material and may be integrally formed with the first cover portion 212 as described above, the installation of the first internal current collecting portion 214 may be completed by simple insertion into the interior of the unit cell 100. Thus, the first cover portion 212 may be formed to adhere closely to the entrance of the end of the unit cell 100. Therefore, the coupling between the first internal current collecting portion 214 and the first cover portion 212 may form a cap structure.

In operation, fuel may be supplied to the interior of the unit cell 100 through the fuel supply port 212a. The first cover portion 212 may be formed to close the entrance of the end of the unit cell 100, and thus may be configured to serve as a stopper to prevent the fuel in the unit cell 100 from leaking.

Thus, as the internal current collecting portion and the cover portion are integrally formed into the cap structure, the installation process of the internal current collecting portion is simplified as compared with the manufacturing process of other similar devices. Also, because the cover portion may simultaneously be formed with the cover portion, the adhesion of the unit cell may be enhanced. Thus, the current collection efficiency of the device is increased as compared to other similar devices.

The first external current collecting portion 216 may be configured for performing external current collection by electrically connecting unit cells. Each unit cell may have such an internal current collection structure formed on an outer circumferential surface of an end portion at which the first cover portion 212 is positioned in the unit cell 100.

In this embodiment, unlike a wire structure, the first external current collecting portion 216 is formed by being coated along an outer circumferential surface of a corresponding section of the unit cell 100. In this configuration, the first external current collecting portion 216 may be formed of the same current collecting material as the first internal current collecting portion 214 using a coating or deposition method.

Since the flat portions 110 may be formed on the outer circumferential surface of the unit cell 100 as described above, the first external current collecting portion 216 may be formed on the flat portions 110. During manufacturing, a coating or deposition process may be performed on the flat portions 110, so that the coating efficiency can be increased as compared with a coating or deposition process performed on the circular portion.

As the first external current collecting portion 216 may be formed using the coating method, the contact area with the unit cell 100 may be increased. Nevertheless, the contact resistance with the unit cell 100 is decreased as compared with a similar device having a wire structure. Accordingly, the current collection efficiency can be enhanced.

Since it is unnecessary to wind a wire around the unit cell, the manufacturing process can be simplified. Further, because a ceramic material may be used rather than a high-priced material such as silver or platinum, the product cost may be significantly reduced.

For reference, the flat portions 110 are formed and configured to increase the coating efficiency of the first external current collecting portion 216. Therefore, if sufficient coating efficiency is obtained even though the unit cell has a circular structure, the flat portions may not be formed.

In addition to the first current collector 210 described above, the second current collector 220 configured to perform internal and external current collection of the cathode may be formed with a structure similar to or even symmetric with the first current collector 210. That is, the second current collector 220 may include a second cover portion 222 covering the other end of the unit cell 100 and a second internal current collecting portion 224 integrally formed with the second cover portion 222 extending in the length direction of the unit cell 100 from the second cover portion 222. A separate external current collecting portion 226 is formed extending from the second cover portion 222 to the outer circumferential surface of the unit cell 100. The second current collector 220 may be formed on the entrance of the other end of the unit cell 100 to correspond to the first current collector 210.

The second internal current collecting portion 224 is not made of a Ni mesh. Instead, the second internal current collecting portion 224 may be formed of a conductive ceramic material similar to the material of the cathode, so that the structure of the second internal current collecting portion 224 is simplified. The second external current collecting portion 226 and the second cover portion 222 may also be formed of the ceramic material to have a porous structure, so that external oxygen can smoothly pass through the second external current collecting portion 226.

The second internal current collecting portion 224 may be integrally formed with the second cover portion 222 using a simple circular ceramic material. Thus, the installation of the second internal current collecting portion 224 may be completed by simply inserting the second internal current collecting portion 224 into the interior of the unit cell 100. The second cover portion 222 may be formed to close the entrance of the corresponding end of the unit cell 100. Therefore, the coupling body between the second internal current collecting portion 224 and the second cover portion 222 may also be formed into a cap structure. Like the first cover portion 212, the second cover portion 222 may serve as a stopper that closes the other end of the unit cell 100.

Like the first external current collecting portion 216, the second external current collecting portion 226 may be formed on the outer circumferential surface of the unit cell 100, for example, the outer circumferential surface of the cathode using a coating method. Further, the second external current collecting portion 226 may be configured to perform external current collection of the cathode.

As the second external current collecting portion 226 is coated on the flat portions 110 of the unit cell as shown in FIG. 3, the coating efficiency can be increased. If sufficient coating efficiency is obtained on a curved surface, the flat portions are not formed, but instead, the second external current collecting portion 226 may be coated directly on the circular cathode. In this configuration, an entire outer circumferential surface of the cathode in the unit cell 100 is exposed to the exterior of the unit cell 100, and oxygen contacts the entire exposed surface. Therefore, the length of the second external current collecting portion 226 coated on the outer circumferential surface of the cathode may be longer than that of the first external current collecting portion 216.

On the other hand, since the first internal current collecting portion 214 contacts the entire length of the anode, the length of the second internal current collecting portion 224 is formed shorter than that of the first internal current collecting portion 214. That is, the length ratios between the first and second internal current collecting portions are opposite to each other.

In the aforementioned description, both the first and second current collectors 210 and 220 have the same structure. However, if necessary, the structure of this embodiment may be selectively applied to one of the first and second current collectors 210 and 220, and the other of the first and second current collectors 210 and 220 may have a different structure.

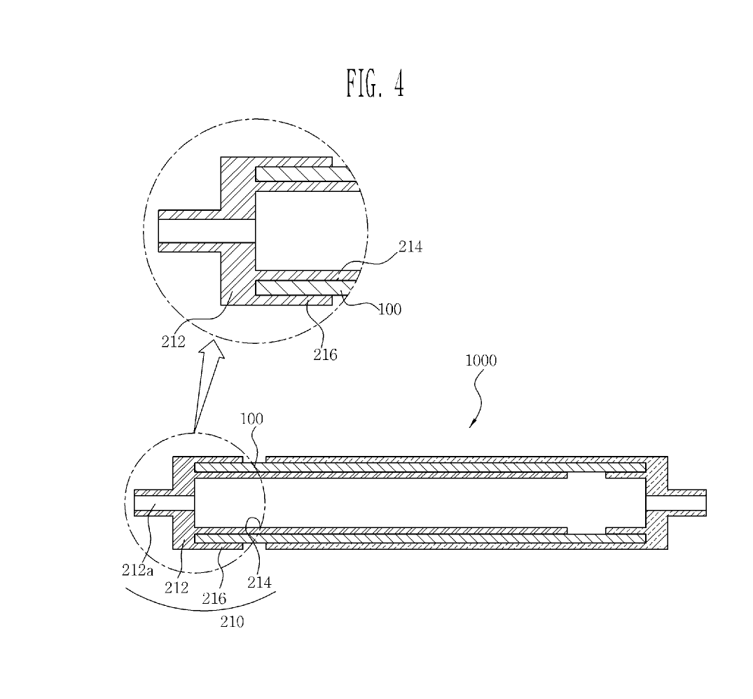

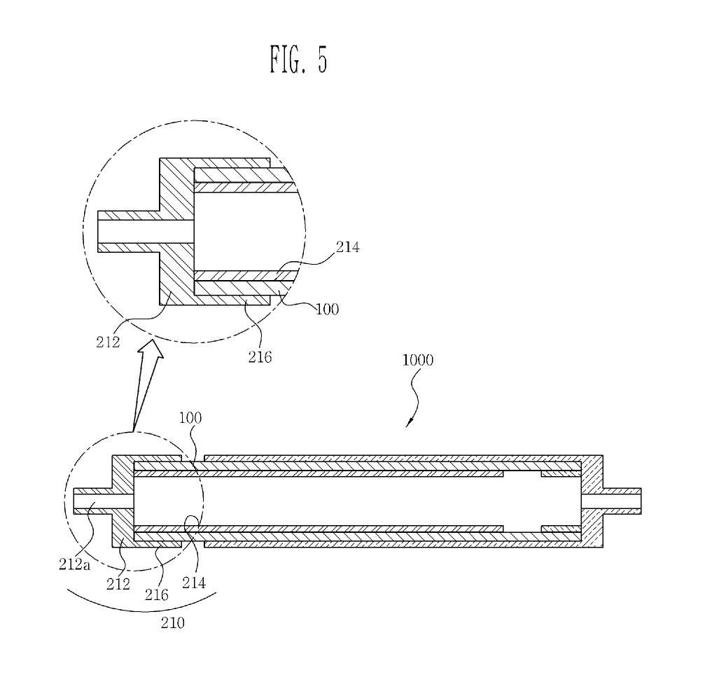

As described above, the coupling structure between the unit cell and each of the first and second collectors may be modified. FIG. 4 is a view showing a coupling structure between the unit cell and each current collector according to one possible modification. The modification has the same basic structure, for example, the coupling structure between the unit cell 100 and each of the first and second current collectors 210 and 220, as the aforementioned structures. However, the modification is different from the aforementioned structures in that the internal current collecting portion 214 and the cover portion 212 of the current collector 210 are not integrally formed in a single body, but instead, the external current collecting portion 216 and the cover portion 212 are integrally formed in a single body.

In this configuration, the external current collecting portion 216 may also be formed using a coating method so as to be integrally formed with the cover portion 212. Alternatively, the external current collecting portion 216 may be formed in the shape of a circular tube with the same external diameter as the unit cell in the state that one end of the external current collecting portion 216 is integrally formed with the cover portion 212, and then inserted into the unit cell 100 using a capping technique. In this configuration, the flat portions of the unit cell 100 may be selectively applied similar to the forming method of the external current collecting portion 216. The internal current collecting portion of alternative structures mentioned above may be applied to the internal current collecting portion 214 of the modification. The internal current collecting portion 214 may be formed of the single ceramic material of the aforementioned embodiment. Before the cover portion 212 is formed, the internal current collecting portion 214 may be formed to be inserted into the unit cell 100.

The structure of the modification may be applied to one or both the current collectors. Further, if the structure of the modification is applied to one of the current collectors, the structure of one of the embodiments discussed above may be applied to the other of the current collectors.

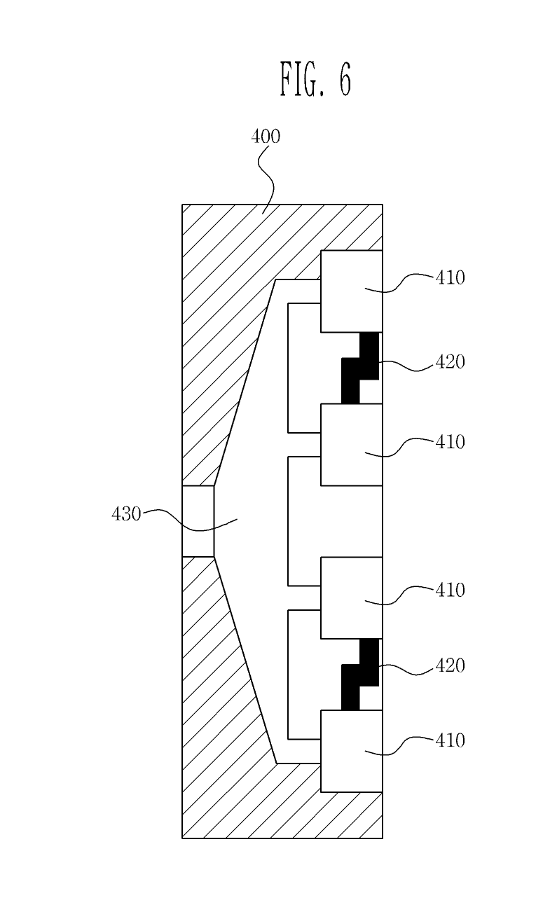

FIG. 5 is a view showing a coupling structure between the unit cell and each current collector according to a second modification. The second modification has the same basic structure as other structures previously discussed. However, the second modification is different in that the internal current collecting portion 214, the cover portion 212 and the external current collecting portion 216 are all formed in a single body so as to be inserted into an end of the unit cell 100 using a capping technique. In this configuration, it is not necessary to perform a coating process and the like, and hence, the installation process of the current collector is further simplified.

The structures of the second modification and the structures of the previously discussed embodiments may be selectively applied to either or both the current collectors.

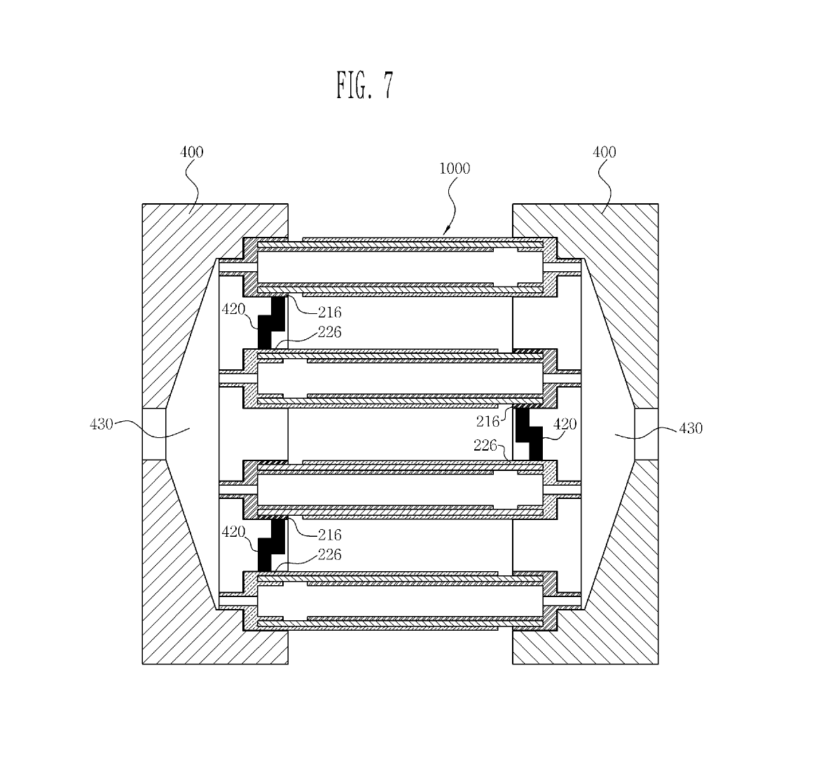

The fuel cells 1000 may have a configuration in which each current collector is inserted into a unit cell using a capping technique. In the configuration in which each current collector is coupled to separate manifolds 400 as shown in FIGS. 6 and 7, the external current collecting connection is established between the fuel cells 1000 and the manifolds 400, thereby electrically connecting one fuel cell stack.

Referring to FIG. 7, the manifolds 400 are positioned at both end portions of the solid oxide fuel cells 1000. Referring to FIG. 6, insertion holes 410 are formed on the opposite surfaces of the manifolds 400. During manufacture, the first and second current collectors 210 and 220 of each of the fuel cells 1000 are inserted into the insertion holes 410. In this configuration illustrated in FIGS. 6 and 7, a connection terminal 420 electrically connects the first or second current collectors 210 or 220 between the fuel cells 1000 is provided between the insertion holes 410. Thus, the current collectors may be inserted into the respective insertion holes 410, and the first and second external current collecting portions 216 and 226 of the unit cells may contact both ends of each of the connection terminals 420. Accordingly, the external current collection connection between the fuel cells 1000 may be formed. That is, the fuel cells 1000 are coupled to the manifolds 400, and the external current collection connection between the fuel cells 1000 is simultaneously formed.

In this instance, as shown in FIG. 7, the ends of each of the unit cells are alternately positioned opposite to each other. In this configuration, the unit cells are electrically connected in series to one another. The serial connection may reduce power consumption as compared with the parallel connection.

As the manifolds are configured as described above, flow paths 430 of the manifolds 400 are formed having a unidirectional flow path structure. Thus, the structure of the manifold can be further simplified.

While the present invention has been described in connection with certain exemplary embodiments, it will be appreciated by those skilled in the art that various modifications and changes may be made without departing from the scope of the present disclosure. It will also be appreciated by those of skill in the art that parts mixed with one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A solid oxide fuel cell, comprising:
a unit cell having a concentric tube structure in which a first electrode, an electrolytic layer and a second electrode are sequentially stacked; and
first and second current collectors electrically connected to one and the other end of the unit cell, respectively,
wherein at least one of the first and the second current collectors is formed on at least one of end and inner circumferential surfaces or end and outer circumferential surfaces of the unit cell.

2. The solid oxide fuel cell of claim 1, wherein the current collector comprises a cover portion positioned on the entrance of the unit cell and an internal current collecting portion extending from a surface of the cover portion opposite to the unit cell configured for insertion into the interior of the unit cell, and wherein the cover portion and the internal current collecting portion are integrally formed in a single body.

3. The solid oxide fuel cell of claim 1, wherein the current collector comprises a cover portion positioned on the entrance of the unit cell and an external current collecting portion extending from a surface of the cover portion opposite to the unit cell to contact an outer circumferential surface of the unit cell, and wherein the cover portion and the external current collecting portion are integrally formed in a single body.

4. The solid oxide fuel cell of claim 2, wherein the internal current collecting portion is formed in a hollow tubular shape so that its outer circumferential surface contacts an inner circumferential surface of the first electrode of the unit cell.

5. The solid oxide fuel cell of claim 3, wherein the external current collecting portion is formed in a hollow tubular shape so that its inner circumferential surface contacts an outer circumferential surface of the unit cell.

6. The solid oxide fuel cell of claim 2 further comprising a fuel supply port is formed in the cover portion.

7. The solid oxide fuel cell of claim 2 further comprising an external current collecting portion formed on the outer circumferential surface of the end of the unit cell, wherein the external current collecting portion is positioned to surround an outer circumferential surface of the unit cell.

8. The solid oxide fuel cell of claim 3 further comprising an internal current collecting portion formed on an inner circumferential surface of the end of the unit cell, wherein the internal current collecting portion contacts an inner circumferential surface of the unit cell.

9. The solid oxide fuel cell of claim 7, wherein the external current collecting portion is integrally formed with the cover portion and the internal current collecting portion.

10. The solid oxide fuel cell of claim 7, wherein flat portions are formed on at least one of the inner and outer circumferential surfaces of the unit cell, and wherein the internal or external current collecting portion is formed on the flat portions.

11. The solid oxide fuel cell of claim 10, wherein the flat portions are formed along the outer circumferential surface of the unit cell, and wherein the unit cell is formed into a polygonal structure.

12. The solid oxide fuel cell of claim 11, wherein the flat portions are locally formed at an end side of the unit cell.

13. The solid oxide fuel cell of claim 2, wherein at least one of the internal current collecting portion and cover portion and the external current collecting portion and cover portion is integrally formed in a single body.

14. The solid oxide fuel cell of claim 2, wherein the current collector comprises a conductive ceramic material.

15. The solid oxide fuel cell of claim 14, wherein the current collector comprises a porous structure.

16. A solid oxide fuel cell stack, comprising:
an assembly of a plurality of unit cells, wherein each of the plurality of unit cells comprises a first electrode, an electrolytic layer and a second electrode, sequentially stacked therein; and
a manifold electrically connected to the plurality of unit cells,
wherein each of the unit cells comprises:
a first current collector comprising a first cover portion provided at one end of the unit cell, a first internal current collecting portion connected to the first cover portion to contact an inner circumferential surface of the unit cell, and a first external current collecting portion electrically connected to the first cover portion to contact an outer circumferential surface of the unit cell,
a second current collector comprising a second cover portion provided at the other end of the unit cell, a second internal current collecting portion connected to the second cover portion to contact the inner circumferential surface of the unit cell, and a second external current collecting portion electrically connected to the second cover portion to contact with the outer circumferential surface of the unit cell,
insertion holes formed in the manifolds, wherein the insertion holes are configured to receive the first and second current collectors of the unit cells, respectively, and
a connection terminal is formed between the insertion holes, wherein the connection terminal is configured to electrically connect the current collectors of the unit cells to each other.

17. The solid oxide fuel cell stack of claim 16, wherein the first current collector is electrically connected to the second current collector.

18. The solid oxide fuel cell stack of claim 16, wherein the first internal current collecting portion of the first current collector is longer than the second internal current collecting portion of the second current collector.

19. The solid oxide fuel cell stack of claim 16, wherein the first external current collecting portion of the first current collector is shorter than the second external current collecting portion of the second current collector.

20. The solid oxide fuel cell stack of claim 16, wherein the first and second external current collecting portions of the unit cells contact each other at both ends of each of the connection terminals in the manifolds.

21. The solid oxide fuel cell stack of claim 16, wherein a fuel supply port is formed in each of the first and second cover portions, and wherein the fuel supply port is in fluid communication with the interior of each of the unit cells.

22. The solid oxide fuel cell stack of claim 16, wherein at least one of the first cover portion and first internal current collecting portion of the first current collector and the second cover portion and second internal current collecting portion of the second current collector are integrally formed in a single body.

23. The solid oxide fuel cell stack of claim 16, wherein at least one of the first cover portion and first external current collecting portion of the first current collector and the second cover portion and second external current collecting portion of the second current collector are integrally formed in a single body.

24. The solid oxide fuel cell stack of claim 16, wherein at least one of the first and second current collectors is integrally formed in a single body.

25. The solid oxide fuel cell stack of claim 16, wherein at least one of the first and second current collectors comprises a conductive ceramic material.

26. The solid oxide fuel cell stack of claim 25, wherein at least one of the first and second current collectors comprises a porous structure.
